(19) United States
(12) Patent Application Publication
(10) Pub. No.: US 2017/0318754 A1
(43) Pub. Date: Nov. 9, 2017

(54) Method for preparation of horticultural mats and plugs from all organic materials

(71) Applicant: Gary R. Hartman, Hollister, CA (US)

(72) Inventor: Gary R. Hartman, Hollister, CA (US)

(73) Assignee: International Horticultural Technologies, Inc., Hollister, CA (US)

(21) Appl. No.: 15/588,634

(22) Filed: May 6, 2017

Related U.S. Application Data
(60) Provisional application No. 62/331,979, filed on May 5, 2016.

(51) Int. Cl. A01G 9/10; A01C 1/04

(52) U.S. Cl. CPC A01G 9/1086; A01G 9/1026; A01C 1/044; A01G 9/102

(57) ABSTRACT

An all Natural growing medium is taught wherein all natural ingredients are incorporated and bound with an all natural latex rubber. The all natural ingredients can include bark, ground bark, Finland peat moss, biochar, coconut fiber and worm castings. In some embodiments the biochar is specially processed in a vacuum chamber to remove small particulates and open pores enabling the absorption and holding of water. The growing medium is then formed into grow plugs or mats.

### CROSS-REFERENCE TO RELATED DOCUMENTS

This US non-provisional patent application claims priority to provisional patent application Ser. No. 62/331,979 filed on May 5, 2016. The entire specification of provisional application Ser. No. 62/331,979 is incorporated in its entirety herein at least by reference.

### BACKGROUND OF THE INVENTION

### 1. Field of the Invention

The present invention is in the field of natural organic growing mediums. Such mediums may be made from all natural organic ingredients and may be formed into plugs for seed and seedling starting as well as mats for growing seedlings and plants.

### 2. Discussion of the State of the Art

Organic foods and products are the fastest-growing items in America's grocery carts with more than $35 billion in annual sales, growing 15 percent per year, comprising approximately 5 percent of all grocery store purchases. Forty-million US households accounting for almost 100 million people are currently buying organic foods, clothing, body care products, supplements and pet food on a regular basis.

Answering the demand for organic products the horticultural industries are also turning to organic materials to start seedlings and plants. One problem in the art is that it is very difficult to form natural organic elements into the desirable shapes with purely organic ingredients. Natural polymers have been found not to be suitable for binding the various growing materials into the proper shapes such as plugs. In fact non-organic polymers must be added to hold the organic materials into the shapes desired. What is clearly needed is a novel growing medium made of purely organic ingredients shaped into desirable forms for starting seeds, seedlings and for growing plants.

Coconut shell and fiber in its raw form has been used for years as a peat moss replacement or adjunct to peat moss as a loose mix for growing pants. Pads of coconut fiber and natural latex have been used as mattresses and for use in baskets and for erosion control. In the art the previously mentioned pads have not been suitable for or used for starting seeds, seedlings or growing plants. These previously mentioned mattresses and pads were legal to ship to the US in that particular form.

The shipping of natural latex that comes straight out of the tree has been banned for some reason by the government and therefore cannot be shipped to the US for use in growing applications. The powers that be have not realized that growers in the US desire a pure way to bind growing materials into plugs, mats and pads for the starting of seedlings and the growth of plants and trees. To date no manufacturer can claim to have an all natural organic plug, mat or pad because materials must be bound by a polymer of some kind. Loose soil is not suitable for the mass starting of seeds and plants on a commercial scale. What is clearly needed is an all organic natural binding material to bind the all natural organic materials into the shape of plugs, mats and pads.

The inventor has discovered that natural rubber or latex straight out of the rubber tree is suitable for this binding of materials for a growing plugs, mats and pads.

### BRIEF SUMMARY OF THE INVENTION

The inventor teaches a novel mixture of real organic growing mediums that use natural and recycled products from other industries. Natural Organic Rubber or Latex has not been used for the binding agent for various materials in order to make a seed starting medium or for the growth of plants. The inventor has discovered that he can have his proprietary mixture of materials bound with all natural organic latex, shaped and shipped from overseas rightfully claiming to have the only natural organic seed and plant starting plugs, mats and pads in the US.

### BRIEF DESCRIPTION OF THE SEVERAL VIEWS OF THE DRAWINGS

FIG. 1 is a photographic representation of growing plugs according to one embodiment of the present invention

FIG. 2 is a photographic representation of individual growing plugs according to one embodiment of the present invention

FIG. 3 is a photographic representation of a mat of coco fiber material and other growing ingredients mixed with a variety of organic growing materials according to one embodiment of the present invention

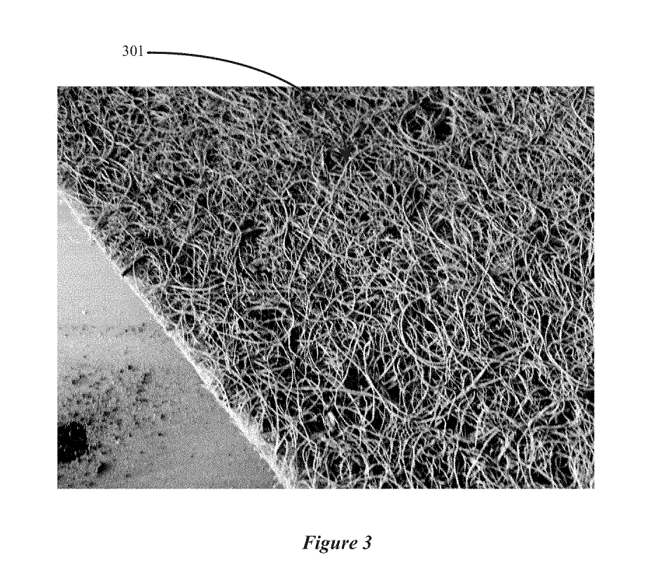

FIG. 4 is an example of all natural materials to be mixed with all natural latex rubber to form an all natural growing medium to be formed into plugs and mats.

### DETAILED DESCRIPTION OF THE INVENTION

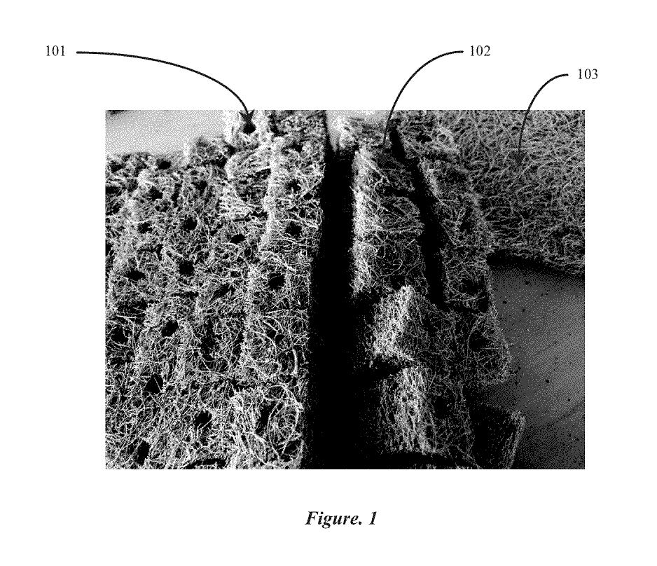

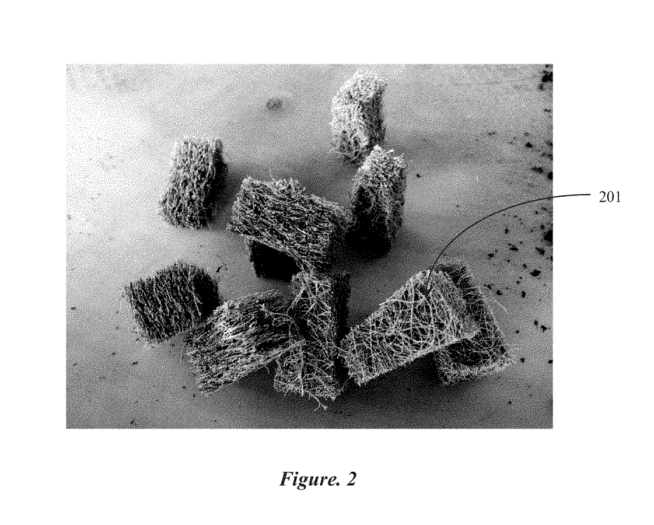

The inventor has discovered that by combining natural organic latex and coconut fiber and or grindings from the entire coconut shell into a stabilized growing medium he could make a natural organic stabilized medium and form it into mats, cells or plugs suitable for starting seeds, seedlings and growing plants. Such mats and plugs can be seen in FIGS. 1 and 2. These mats and plugs are made entirely from natural organic latex and coconut fiber as well as other materials when desired and are sufficient for starting seeds, growing seedlings and plants. Referring to FIG. 1, the seeds are inserted into openings 101 and then top watered for germination.

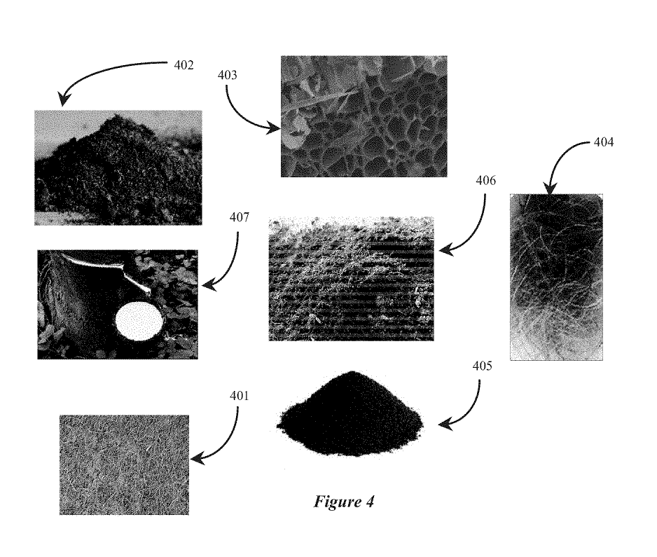

The natural latex used in this invention is natural organic latex (FIG. 4 element 407) from Sri Lanka. Current law prohibits natural un-processed latex from entering into the United States. The rubber tree cannot grow in the US due to climate limitations. All of the products previously made from natural rubber are now made from all synthetic urethane products. The inventor has devised a way to produce a product made overseas that can be legally shipped to the US and contains all natural organic latex mixed with the other natural organic products.

The inventor has identified other natural organic ingredients that in one embodiment help to retain water and add nutrient value to the mats and plugs made from coconut fiber and natural organic latex rubber. Referring to FIG. 4, coconut fiber 404 and natural organic latex 407 are mixed with additional materials and processed into a natural organic stabilized growing media using at least one of tree or plant bark (not shown), processed burnt bark, organic materials such as biochar 403, peat moss 402, Finland peat moss, and worm castings 405. FIG. 4 element 406 represents a mixture of the above ingredients. This stabilized media containing these materials in various amounts is processed into individual cells, plugs or a mats designed to start seeds, seedlings and for growing plants. The mats and plugs can be made into any size and for any scale for the starting and growing of seeds, seedlings or plants from a small personal scale to an industrial scale. This additional embodiment is described in enabling detail using the following examples, which may describe more than one relevant embodiment falling within the scope of the present invention.

One of the ingredients of the mixture mentioned above is biochar. Biochar is defined simply as charcoal that is used for agricultural purposes. It is created using a pyrolysis process which is the heating of a biomass in a low oxygen environment.

Once it is produced biochar is typically spread on agricultural fields and incorporated into the top layer of soil. Biochar has many agricultural benefits. It increases crop yields, sometimes substantially if the soil is in poor condition. It helps to prevent fertilizer runoff and leeching, allowing the use of less fertilizers and diminishing agricultural pollution to the surrounding environment. Biochar also retains moisture, helping plants through periods of drought more easily. Most importantly, it replenishes exhausted or marginal soils with organic carbon and fosters the growth of soil microbes essential for nutrient absorption, particularly mycorrhizal fungi.

Due to government subsidies biochar is being used more and more in horticulture and agriculture. Biochar is typically made in small amounts and is not available as a stabilized product on an industrial scale.

Typical biochar contains many very small particulates which are not ideal for the manufacture of mats and plugs for the horticultural industry which is why it has never been used. If it was used for plugs or mats the produce would be a mess putting off a fine messy black powder making it impossible to work with of ship. In order for it to be successfully used as an ingredient in making mats and plugs the inventor's biochar is taken a step further. The material is washed in a vessel and put under a vacuum to remove small particulates. This process also opens the pores of the biochar making it retain more water which is desirable. These lager particles of biochar with honeycomb like openings are much more desirable (see FIG. 4 element 403). After washing, treating with a vacuum and drying the PH of the biochar mentioned above is typically alkaline so is adjusted with an acid to raise the PH value to a suitable level for a plant starting medium. An example of the processed biochar can be seen in FIG. 4 as element 403. This image depicts biochar after treatment mentioned above. As one can see the honeycomb like open pores of the biochar are ideal for absorbing and holding water. The feature is vital for the viability of a plug or mat that can actually hold water for long periods. This feature makes it ideal for an organic ingredient in the manufacture of plugs and mats designed for seed starting and growing plants. It also adds nutrients as well.

A combination of at least natural organic latex, coconut fiber or ground coconut shell and one or more of the organic materials biochar, ground bark, peat moss or worm castings are selected for the manufacture of plugs and mats that have a very high water retention value. The natural organic latex material is included in with the mix of raw materials to give the medium resiliency in holding a formed shape. The inventor may use natural organic latex, coconut fiber and any one or several of the materials mentioned above. Any other organic growing material not mentioned may be mixed with latex and coconut fiber in order to form mats and or plugs without departing from the spirit and scope of the invention.

Once all of the materials stabilize, they may be trimmed into shippable products such as individual or collective potting plugs or into a mat profile. FIG. 1 illustrates the materials after being formed into plugs 102 and mats 103. Center bores are provided in the plugs to make room for one or more plant seedlings, starter transplants, seeds or larger plantings. The openings 101 may be made in the plugs by a die or a drill but not limited to these methods. The mixed materials mentioned above may be processed into mats and plugs by any method known in the art. The plugs may be cut, shaped or formed in twos, fours, sixes and eights, in place of individual shapes without departing from the spirit and scope of the present invention. Mat 103 may be cut, shaped or formed from a larger roll of pre-manufactured material. In other words the several ingredients and the latex may be mixed and shaped into a roll from which the plugs or mats may be cut, formed or shaped with the appropriate machinery such as dies and presses.

One with skill in the art will appreciate that all of or a combination of the raw materials shown in FIG. 4 may be used to create the medium without departing from the spirit and scope of the present invention. The biochar is the only ingredient that receives processing. It will also be apparent to the skilled artisan that a user may cut multiple plugs from a mat of growing medium wherein such plugs may be singular plugs or grouped plugs to hold more plants. Such plugs are purely organic and may be provided in solo or in symmetrical groups of plugs to consumers and other operations such as nurseries and farming concerns. The ingredients may also be mixed with the latex and then shaped and or formed into mats or plugs while the mixture is still hot and has not yet cured and cooled down. It is also possible to mix the natural organic latex with the various growing materials mentioned above while the latex is liquid and cool. The point is that the mixing of the latex and the materials and them forming the mats, plugs and other various shapes

It will be apparent to one with skill in the art that the plant medium preparation system and plug apparatus of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A natural organic growing medium shaped plug comprising;
at least one of a bark, a ground bark, ground coconut shell, worm castings, Finland peat moss, or bio char;
a biochar being washed in a vessel under a vacuum wherein all small particulates are removed;
a drying of washed biochar;
a PH treatment of washed and dried biochar to a PH level suitable for the starting of seeds and the growth of plants;
wherein the washing under vacuum, the drying and the PH treatment render a biochar product with honeycomb shape openings suitable to absorb and hold water;
a natural organic unprocessed latex rubber wherein the natural organic unprocessed latex rubber is mixed with the at least one or more of a bark, a ground bark, ground coconut shell, worm castings, Finland peat moss, biochar and or processed bio char to form a mixture suitable for the formation of a plug suitable for the starting of a plant or tree seed

2. A natural organic growing medium shaped mat comprising;
at least one of a bark, a ground bark, ground coconut shell, worm castings, Finland peat moss, or bio char.
a biochar being washed in a vessel under a vacuum wherein all small particulates are removed
drying of washed biochar
PH treatment of washed and dried biochar to a PH level suitable for the starting of seeds and the growth of plants.
wherein washing under vacuum, drying and PH treatment render a biochar product with honeycomb shape openings suitable to absorb and hold water
a natural organic unprocessed latex rubber wherein the natural organic unprocessed latex rubber is mixed with the at least one or more of a bark, a ground bark, ground coconut shell, worm castings, Finland peat moss and, processed bio char to form a mixture suitable for the formation of a mat suitable for the starting of a plant or tree seed
